(19) United States
(12) Patent Application Publication
(10) Pub. No.: US 2024/0131551 A1
(43) Pub. Date: Apr. 25, 2024

(54) VARNISH INJECTOR ASSEMBLY WITH VARNISH FLOW FEATURE

(71) Applicant: Ford Global Technologies, LLC, Dearborn, MI (US)

(72) Inventor: Xiaogang Zhang, Novi, MI (US)

(73) Assignee: Ford Global Technologies, LLC, Dearborn, MI (US)

(21) Appl. No.: 17/969,332

(22) Filed: Oct. 18, 2022

(51) Int. Cl. B05C 7/00; H02K 15/02

(52) U.S. Cl. CPC B05C 7/005; H02K 15/024

(57) ABSTRACT

A varnish injector assembly for an electric motor includes an injector nozzle, a varnish reservoir fluidly connected to the injector nozzle, and a filament extending from the varnish reservoir. The filament is configured to direct varnish from the injector nozzle to a slot of a stator core.

### FIELD

The present disclosure relates to electric motors, and more specifically to applying varnish to a stator.

### BACKGROUND

The statements in this section merely provide background information related to the present disclosure and may not constitute prior art.

Electric propulsion systems in vehicles use electric motors to propel the vehicle as an alternative or in addition to internal combustion engines. Generally, varnish is applied to the electric motors to protect against corrosion and contaminant, thereby improving an operation life of the electric propulsion system. The varnish can be applied with a machine designed to apply the varnish to various components of the motors. During application, varnish may flow away from an intended location or component that uses the varnish, increasing the total amount of varnish used and potentially disrupting operation of other parts of the electric motor.

The present disclosure addresses challenges related to varnish application to electric motors.

### SUMMARY

This section provides a general summary of the disclosure and is not a comprehensive disclosure of its full scope or all of its features.

In one form, a varnish injector assembly includes an injector nozzle, a varnish reservoir fluidly connected to the injector nozzle, and a filament extending from the varnish reservoir. The filament is configured to direct varnish from the injector nozzle to a slot of a stator core.

In variations of the assembly, which may be implemented individually or in combination: an applicator disposed at an end of the filament, the applicator configured to direct the varnish from the filament into the slot of the stator core; the filament is metal; the varnish reservoir receives the varnish from the injector nozzle; the varnish reservoir supplies the varnish to the injector nozzle; the filament extends from the varnish reservoir through the injector nozzle; a support securing the filament in the varnish reservoir; the support includes a plurality of rigid legs extending beyond a diameter of an outlet of the varnish reservoir; the support extends beyond a diameter of the injector nozzle; the support is fixed to the varnish reservoir; the filament is disposed above a wire disposed in the slot of the stator core; an applicator disposed at an end of the filament, the applicator contacting the wire; the applicator is a fiber brush; the filament extends along a direction of gravity, and varnish from the varnish reservoir flows along the filament along the direction of gravity.

A varnish application system includes a stator core of an electric motor, the stator core defining a slot and comprising a wire disposed in the slot, a varnish injector disposed above the slot, and a filament extending through the varnish injector to the slot. The varnish injector is configured to provide varnish to the wire via the filament.

In variations of the system, which may be implemented individually or in combination: a support securing the filament in a varnish reservoir; an applicator disposed on an end of the filament, the applicator contacting the wire; the varnish injector includes a varnish reservoir fixed to an injector nozzle; the filament is disposed in the varnish reservoir; the filament extends from the varnish reservoir through the injector nozzle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an electric motor according to the present disclosure;

FIG. 2 is a schematic view of a varnish injector assembly according to the present disclosure;

FIG. 3 is a cross-sectional view of the varnish injector assembly of FIG. 2 according to the present disclosure;

FIG. 4 is a schematic view of another form of a varnish injector assembly according to the present disclosure; and

FIG. 5 is a cross-sectional view of the varnish injector assembly of FIG. 4 according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Among other components, an electric motor includes a stator that is a stationary component generating an electromagnetic field and a rotor which rotates relative to the stator due to the electromagnetic field. The electric motor is a component of an electric propulsion for a motor vehicle such as an “electric vehicle.” The electric motor propels the motor vehicle by rotating one or more wheels of the motor vehicle. In one example, the electric motor is a sole propulsion of the vehicle, such as in a fully electric vehicle. Alternatively, the electric motor can be part of a hybrid propulsion that includes an internal combustion engine, such as in a hybrid-electric vehicle.

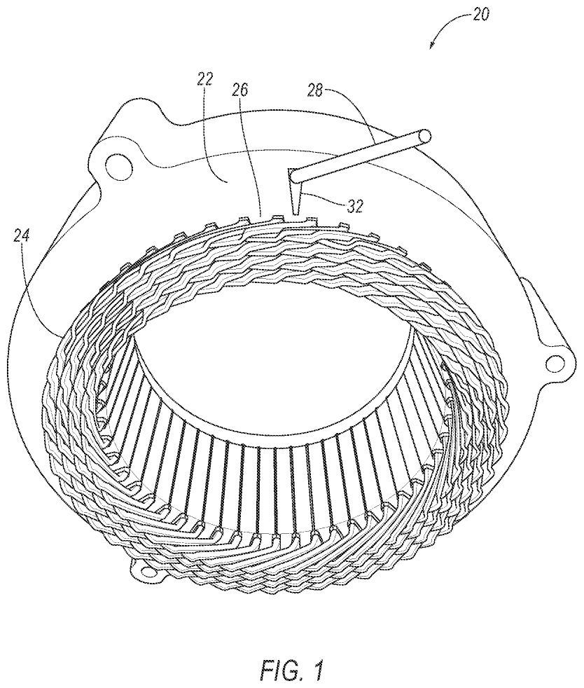

With reference to FIG. 1, an example of a stator 20 for an electric motor is illustrated and includes a stator core 22 and a plurality of wires 24. In one form, the stator core 22 defines a plurality of slots 26, and one or more wires 24 from among the plurality of wires 24 reside in each slot 26. The wires 24 are formed of an electrically conducting material, such as copper. With the wires 24 arranged in the slots 26, electric current flow through the wire 24 generating electromagnetic field that drives the rotor.

To inhibit corrosion or deterioration of electrical properties of the wires and to improve durability of the stator by holding stator laminates and/or copper wires and/or intermediate paper layers together in a generally rigid manner, a varnish (not shown) is applied to the stator during assembly of the electric motor. The varnish is typically applied to an outermost surface of the stator core 22 with a varnish injector 28 with an injector nozzle 32, and capillary action directs the flow of the varnish through the slot 26 and onto the wires 24 as well as into a gap between a surface of the slot 26 and the intermediate paper layer (not shown). Specifically, the varnish flows in narrow spaces (i.e., capillaries), such as the slot 26, by adhesion, viscosity, and/or surface tension with the slot 26 without significant influence by, or even against, the force of gravity. The stator core 22 is rotated such that a varnish injector 28 applying the varnish can inject the varnish to each of the slots 26 and the wires 24 therein. When applying varnish to the stator core 22, excess varnish spreading away from the slot 26 may interfere with other parts of the stator 20, potentially inhibiting operation thereof, and increases a total amount of varnish needed for the stator core 22. Controlling flow of varnish into the slots 26 reduces a total amount of varnish used and improves manufacturing of the electric motor, addressing this concern with conventional stator cores.

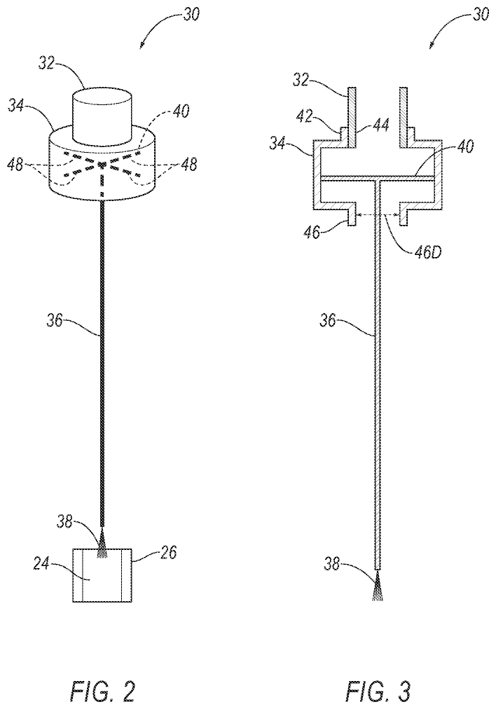

With reference to FIGS. 2-3, a varnish injector assembly 30 of the present disclosure is adapted to be employed with the varnish injector 28 to control flow of varnish. More particularly, the varnish injector assembly 30 includes the injector nozzle 32, a varnish reservoir 34, a filament 36, an applicator 38 disposed at an end of the filament 36, and a support 40 disposed within the varnish reservoir 34.

The injector nozzle 32 provides varnish from a varnish supply (not shown) to the varnish reservoir 34. For instance, in the example provided, the injector nozzle 32 is part of the varnish injector 28 to provide varnish to the reservoir 34. An inlet 42 of the varnish reservoir 34 is fluidly coupled to an outlet 44 of the injector nozzle 32 forming a friction fit or the like. The varnish reservoir 34 stores varnish to be applied to the wires 24 in the stator core 22. By placing the varnish reservoir 34 below the injector nozzle 32, the varnish injector assembly 30 can be retrofitted to existing injector nozzles 32 on varnish injectors 28 by attaching the varnish reservoir 34 to the outlet 44 of the injector nozzle 32. The injector nozzle 32 is formed of a conventional material, such as metal or a polymer.

The filament 36 extends through an outlet 46 of the varnish reservoir 34 to direct varnish to one of the slots 26 of the stator core 22. The filament 36 is disposed vertically above a wire 24 disposed in the slot 26 of the stator core 22, such as the wires 24 shown in FIG. 1, during application of the varnish. The filament 36 extends downward from the varnish reservoir 34 along a direction of gravity, and varnish from the varnish reservoir 34 flows along the filament 36 along the direction of gravity. That is, the viscosity of the varnish causes the varnish to flow along the filament 36, inhibiting fluid buildup of the varnish and/or deviation of the varnish flow away from the slot 26. In such a form, a gravity-based varnish injector assembly 30 provides varnish to the wires 24 in the slot 26 of the stator core 22 with less deviation of the varnish flow. In one form, the filament 36 is metal.

The applicator 38 provided at the end of the filament 36 is configured to direct the varnish from the filament 36 into the slot 26 of the stator core 22. In one form, the applicator 38 is a fiber brush that contacts the wire 24 in the slot 26, providing varnish flowing along the filament 36 onto the fiber brush and onto the wire 24. The fibers of the fiber brush spread the varnish onto the wire 24, improving application of varnish to the stator core 22.

The support 40 secures the filament 36 in the varnish reservoir 34. In one form, the support 40 includes a plurality of rigid legs 48 extending beyond a diameter 46D of the outlet of the varnish reservoir 34. The legs 48 of the support 40 secure the support 40 in the varnish reservoir 34. By extending beyond the diameter 46D of the outlet 46, the legs 48 are stopped from moving out from the varnish reservoir 34. In one form, the support 40 is fixed to the varnish reservoir 34. In another form, the support 40 floats freely within the varnish reservoir 34.

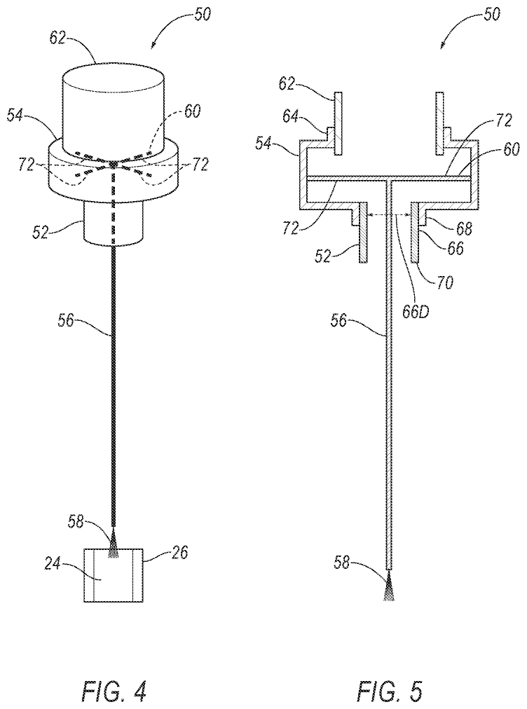

In another form, with reference to FIGS. 4-5, a varnish injector assembly 50 is configured to replace a conventional varnish injector (such as the varnish injector 28 described above) and includes an injector nozzle 52, a varnish reservoir 54, a filament 56, an applicator 58 disposed at an end of the filament 56, and a support 60 disposed in the varnish reservoir 54. The varnish reservoir 54 is disposed above the injector nozzle 52, and the filament 56 extends from the varnish reservoir 54 through the injector nozzle 52 and toward the applicator 58, such as a fiber brush described above. A varnish supply 62 is fixed to an inlet 64 of the varnish reservoir 54 and provides varnish to the varnish reservoir 54. An inlet 66 of injector nozzle 52 is fixed to an outlet 68 of the varnish reservoir 54. The filament 56 extends from the varnish reservoir 54 through the outlet 70 of the injector nozzle 52.

As with the varnish injector assembly 30 of FIGS. 2-3, the varnish injector assembly 50 of FIGS. 4-5 includes the support 60 securing the filament 56 in the varnish reservoir 54. As with the support 40, the support 60 includes a plurality of rigid legs 72 extending beyond a diameter 66D of the inlet 66 of injector nozzle 52 to inhibit movement of the filament 56 out from the varnish reservoir 54. The legs 72 of the support 60 secure the support 60 in the varnish reservoir 54. By extending beyond a diameter 66D of the inlet 66, the legs 72 are inhibited from moving out from the injector nozzle 52. In one form, the support 60 is fixed to the varnish reservoir 54. In another form, the support 60 floats freely within the varnish reservoir 54.

In operation, the varnish reservoir 54 supplies varnish to the injector nozzle 52, which directs the varnish onto the filament 56. The varnish flows from the outlet 68 of the varnish reservoir 54 into the inlet 66 of the injector nozzle 52, and then along the filament 56 from the inlet 66 to an outlet 70 of the injector nozzle 52 onto the applicator 58 and onto the wire 24 disposed in the slot 26 of the stator core 22. By disposing the injector nozzle 52 below the varnish reservoir 54 such that filament 56 extends therethrough, varnish flow through the injector nozzle 52 remains consistent from the varnish reservoir 54. This consistent flow reduces deviations of the varnish flow, and each slot 26 of the stator core 22 receives similar amounts of varnish. In the form shown, the inlet 66 of the injector nozzle 52 is fixed to the outlet 68 of the varnish reservoir 54 with a friction fit or the like, and the injector nozzle 52 can be replaced with a different injector nozzle 52, such as one with a different size or shape configured for specific varnish applications. In another form not shown, the injector nozzle 52 is integral with the varnish reservoir 54.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A varnish injector assembly for an electric motor, the assembly comprising:
an injector nozzle;
a varnish reservoir fluidly connected to the injector nozzle; and
a filament extending from the varnish reservoir,
wherein the filament is configured to direct varnish from the injector nozzle to a slot of a stator core.

2. The assembly of claim 1, further comprising an applicator disposed at an end of the filament, the applicator configured to direct the varnish from the filament into the slot of the stator core.

3. The assembly of claim 1, wherein the filament is metal.

4. The assembly of claim 1, wherein the varnish reservoir receives the varnish from the injector nozzle.

5. The assembly of claim 1, wherein the varnish reservoir supplies the varnish to the injector nozzle.

6. The assembly of claim 5, wherein the filament extends from the varnish reservoir through the injector nozzle.

7. The assembly of claim 1, further comprising a support securing the filament in the varnish reservoir.

8. The assembly of claim 7, wherein the support includes a plurality of rigid legs extending beyond a diameter of an outlet of the varnish reservoir.

9. The assembly of claim 7, wherein the support extends beyond a diameter of the injector nozzle.

10. The assembly of claim 7, wherein the support is fixed to the varnish reservoir.

11. The assembly of claim 1, wherein the filament is disposed above a wire disposed in the slot of the stator core.

12. The assembly of claim 11, further comprising an applicator disposed at an end of the filament, the applicator contacting the wire.

13. The assembly of claim 12, wherein the applicator is a fiber brush.

14. The assembly of claim 1, wherein the filament extends along a direction of gravity, and varnish from the varnish reservoir flows along the filament along the direction of gravity.

15. A varnish application system, the system comprising:
a stator core of an electric motor, the stator core defining a slot and comprising a wire disposed in the slot;
a varnish injector disposed above the slot; and
a filament extending through the varnish injector to the slot,
wherein the varnish injector is configured to provide varnish to the wire via the filament.

16. The system of claim 15, further comprising a support securing the filament in a varnish reservoir.

17. The system of claim 15, further comprising an applicator disposed on an end of the filament, the applicator contacting the wire.

18. The system of claim 15, wherein the varnish injector includes a varnish reservoir fixed to an injector nozzle.

19. The system of claim 18, wherein the filament is disposed in the varnish reservoir.

20. The system of claim 19, wherein the filament extends from the varnish reservoir through the injector nozzle.
